(19) United States
(12) Patent Application Publication
(10) Pub. No.: US 2014/0003087 A1
(43) Pub. Date: Jan. 2, 2014

(54) LED Panel Lighting Device

(71) Applicant: KOCAM INTERNATIONAL CO., LTD., NNew Taipei City (TW)

(72) Inventor: Tsan-Jung Chen, New Taipei City (TW)

(73) Assignee: Kocam International Co., Ltd., New Taipei City (TW)

(21) Appl. No.: 13/890,249

(22) Filed: May 9, 2013

(30) Foreign Application Priority Data
Jun. 29, 2012 (TW) 101212613

(51) Int. Cl. F21V 8/00

(52) U.S. Cl. CPC G02B 6/0085
USPC 362/606

(57) ABSTRACT

The present invention relates to a LED panel lighting device, comprising: a back framework, an assembled housing, at least two circuit layer, a plurality of LED chips, a light guide plate, a bottom reflective member, and an optical diffusion member, wherein the assembled housing is consisted of a plurality of housing edges, and the circuit layers are disposed in the housing edges via a thermal conductive and electric insulating member, so as to be disposed with the LED chips. In the present invention, it mainly disposes the circuit layers with the LED chips into the housing edges by the thermal conductive and electric insulating member, without using any MCPCBs. Therefore, comparing to the conventional LED panel lighting device, this LED panel lighting device would not produce any heat accumulation issue because the MCPCB does not used in this LED panel lighting device.

### BACKGROUND OF THE INVENTION

1. Field of the Invention

The present invention relates to an LED light device, and more particularly to an LED panel lighting device.

2. Description of the Prior Art

Recently, light emitting diode (LED) devices are widely used in lighting device of human life, and there are many LED lighting device sold in the market, for example, LED cup lighting devices, LED bulbs, LED lamps, LED downlights, and LED panel lighting devices.

Please refer to FIG. 1, which illustrates an exploded view of a conventional LED panel lighting device. As shown in FIG. 1, the LED panel lighting device 1′ includes: a back plate 101′, a reflective sheet 102′, a light guide plate 103′, an optical diffusion sheet 104′, two LED light bars 20′, four edges 30′, and four outer edges 40. The reflective sheet 102′, the light guide plate 103′ and the optical diffusion sheet 104′ are sequentially disposed on the back plate 101′, and the two LED light bars 20′ are respectively disposed on the left edge 30′ and the right edge 30′. Moreover, after the reflective sheet 1022, the light guide plate 103′, the optical diffusion sheet 104′, and the LED light bars 20′ are have been installed, the four edges 30′ are then assembled to the four side edges of the back plate 101′; and furthermore, the four outer edges 40′ are used to cover and protect the four edges 30′, respectively.

The above-mentioned LED panel lighting device 1′ includes the advantages of simple structure and being able to be assembled easily, however, it still has the shortcomings as follows.

In the LED panel lighting device 1′, the LED light bar 20′ is consisted of a MCPCB and a plurality of LED chips; so that, when the LED chips emit light, the heat produced by the LED chips cannot be effectively dissipated because the MCPCB is not a good heat dissipating material, such that the heat produced by the LED chips would eventually accumulated in the edges 30′; and more seriously, the accumulated heat may causes damages on the LED chips.

Accordingly, in view of the conventional LED panel lighting device still have shortcomings and drawbacks, the inventor of the present application has made great efforts to make inventive research thereon and eventually provided an LED panel lighting device.

### SUMMARY OF THE INVENTION

The first objective of the present invention is to provide an LED panel lighting device, in which the circuit layers with the LED chips are disposed into the housing edges of a back framework by a thermal conductive and electric insulating member, without using any MCPCBs, such that this LED panel lighting device would not produce any heat accumulation issue.

The second objective of the present invention is to provide an LED panel lighting device, in which the circuit layers with the LED chips are disposed into the housing edges of a back framework by a thermal conductive and electric insulating member, without using any MCPCBs, such the housing edges of the back framework of this LED panel lighting device can be made to be thinner.

Accordingly, to achieve the first and second objectives of the present invention, the inventor of the present invention provides an LED panel lighting device, comprising:

a back framework;

an assembled housing, consisted of a plurality of housing edges and combined with the back framework by way of enclosing the back framework;

at least two circuit layers, disposed in two housing edges of the assembled housing by a thermal conductive and electric insulating member;

a plurality of LED chips, disposed on the circuit layers;

a light guide plate, disposed in the assembled housing and on the back framework, and having at least two light receiving surfaces and a light emitting surface, wherein the light receiving surfaces is used for receiving the light emitted from the LED chips, and then the light emitting surface would further provide a light source;

a bottom reflective member, disposed on the bottom surface of the light guide plate; and

an optical diffusion member, disposed on the light emitting surface of the light guide plate, used for homogenizing the light source.

The third objective of the present invention is to provide an LED panel lighting device, in which the circuit layers with the LED chips are disposed into the disposing portions of housings of a back framework by a thermal conductive and electric insulating member, without using any MCPCBs, such that this LED panel lighting device would not produce any heat accumulation issue.

The fourth objective of the present invention is to provide an LED panel lighting device, in which the circuit layers with the LED chips are disposed into the disposing portions of housings of a back framework by a thermal conductive and electric insulating member, without using any MCPCBs, such this LED panel lighting device can be made to be thinner.

So that, to achieve the third and fourth objectives of the present invention, the inventor of the present invention provides an LED panel lighting device, comprising:

a geometric-shaped back framework, consisted of a bottom plate and a plurality of edges;

at least two circuit carrying bodies, disposed in the geometric-shaped back framework 10a and closely adjoining the edges;

at least two circuit layers, disposed on the circuit carrying bodies by a thermal conductive and electric insulating member;

a plurality of soldering metal sheets, wherein each of the soldering metal sheets have a first soldering portion and a second soldering portion, and the first soldering portion are provided having an insulating layer with a first opening on the inner and outer surfaces thereof, in which the first opening is used for being welded with a plurality of welding pads of the circuit layers; moreover, the second soldering portion is also provided having an insulating layer with a second opening on the inner and outer surfaces, and the second opening is used for being welded with the plurality of welding pads of the circuit layers;

a plurality of LED chips, welded on the second soldering portions via the second openings, and electrically connected to the circuit layers via the soldering metal sheets;

a light guide plate, disposed in the geometric-shaped back framework and located on the bottom plate, and having at least two light receiving surfaces and a light emitting surface, wherein the light receiving surfaces is used for receiving the light emitted from the LED chips, and then the light emitting surface would further provide a light source;

a bottom reflective member, disposed on the bottom surface of the light guide plate; and

an optical diffusion member, disposed on the light emitting surface of the light guide plate, used for homogenizing the light source.

Moreover, to achieve the third and fourth objectives of the present invention, the inventor of the present invention provides an LED panel lighting device, comprising:

a geometric-shaped back framework, consisted of a bottom plate and a plurality of edges;

at least two housing, disposed in the geometric-shaped back framework and closely adjoining the edges, wherein each of the housing have a first disposing portion and a second disposing portion;

at least two circuit layers, disposed on the first disposing portions by a thermal conductive and electric insulating member;

a plurality of LED chips, disposed on the circuit layers;

a light guide plate, disposed in the geometric-shaped back framework and located on the bottom plate, and having at least two light receiving surfaces and a light emitting surface, wherein the light receiving surfaces is used for receiving the light emitted from the LED chips, and then the light emitting surface would further provide a light source;

a bottom reflective member, disposed on the bottom surface of the light guide plate; and

an optical diffusion member, disposed on the light emitting surface of the light guide plate, used for homogenizing the light source.

The fifth objective of the present invention is to provide an LED panel lighting device, in which the circuit layers with the LED chips are disposed into the inner surfaces of a back framework by a thermal conductive and electric insulating member, without using any MCPCBs, such this LED panel lighting device can be made to be thinner.

So that, to achieve the fifth objective of the present invention, the inventor of the present invention provides an LED panel lighting device, comprising:

a geometric-shaped back framework, consisted of a bottom plate and a plurality of edges;

at least two circuit layers, disposed on the edges by a thermal conductive and electric insulating member;

a plurality of LED chips, disposed on the circuit layers;

a light guide plate, disposed in the geometric-shaped back framework and located on the bottom plate, and having at least two light receiving surfaces and a light emitting surface, wherein the light receiving surfaces is used for receiving the light emitted from the LED chips, and then the light emitting surface would further provide a light source;

a bottom reflective member, disposed on the bottom surface of the light guide plate; and

an optical diffusion member, being disposed on the light emitting surface of the light guide plate, used for homogenizing the light source.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 is an exploded view of a conventional LED panel lighting device;

FIG. 2 is an exploded view of a LED panel lighting device according to the present invention;

FIG. 3 is a stereo view of the LED panel lighting device according to the present invention;

FIG. 4 is a cross-sectional view of the LED panel lighting device according to the present invention;

FIG. 5 is a second stereo view of the LED panel lighting device according to the present invention;

FIG. 6 is a third stereo view of the LED panel lighting device according to the present invention;

FIG. 7 is a second cross-sectional view of the LED panel lighting device according to the present invention;

FIG. 8 is a stereo view of a second embodiment of the LED panel lighting device according to the present invention;

FIG. 9 is a cross-sectional view of the second embodiment of the LED panel lighting device according to the present invention;

FIG. 10 is a stereo view of a plurality of soldering metal sheets of the LED panel lighting device;

FIG. 11A is a front view of the soldering metal sheets of the LED panel lighting device;

FIG. 11B is a bottom view of the soldering metal sheets of the LED panel lighting device;

FIG. 12 is a stereo view of a third embodiment of the LED panel lighting device according to the present invention;

FIG. 13 is a cross-sectional view of the third embodiment of the LED panel lighting device according to the present invention;

FIG. 14 is a stereo view of a fourth embodiment of the LED panel lighting device according to the present invention;

FIG. 15 is a cross-sectional view of the fourth embodiment of the LED panel lighting device according to the present invention;

FIG. 16 is a second cross-sectional view of the fourth embodiment of the LED panel lighting device according to the present invention;

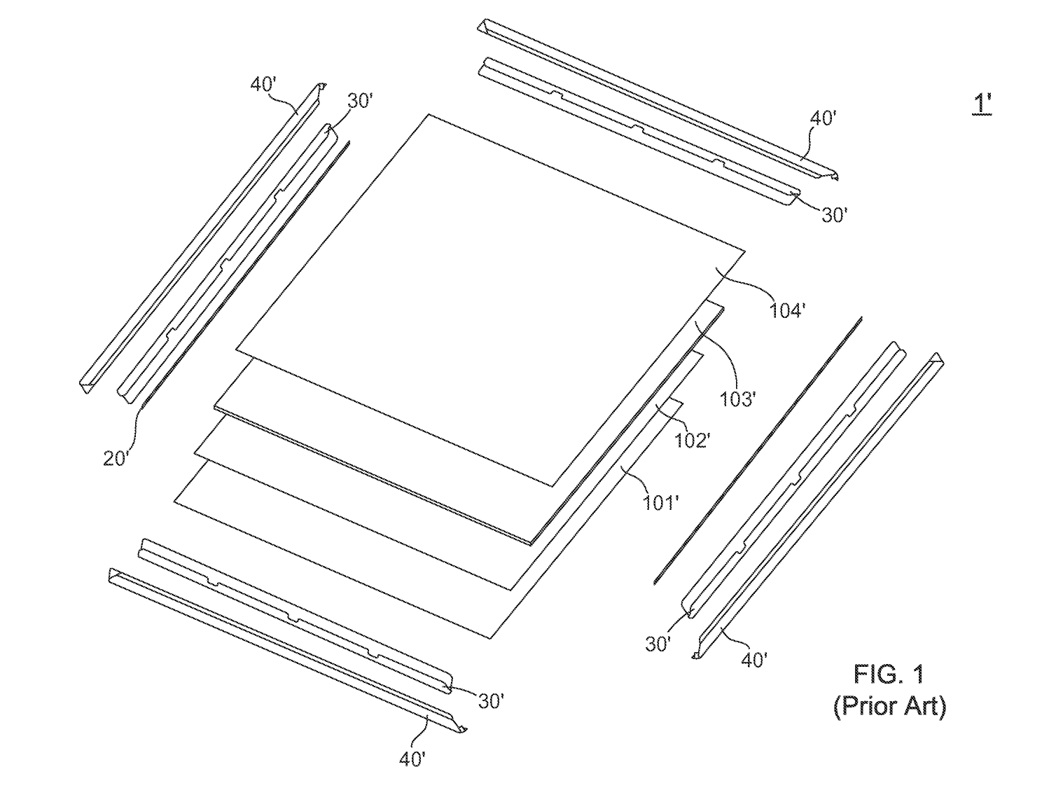

### DETAILED DESCRIPTION OF THE PREFERRED EMBODIMENTS

To more clearly describe an LED panel lighting device according to the present invention, embodiments of the present invention will be described in detail with reference to the attached drawings hereinafter.

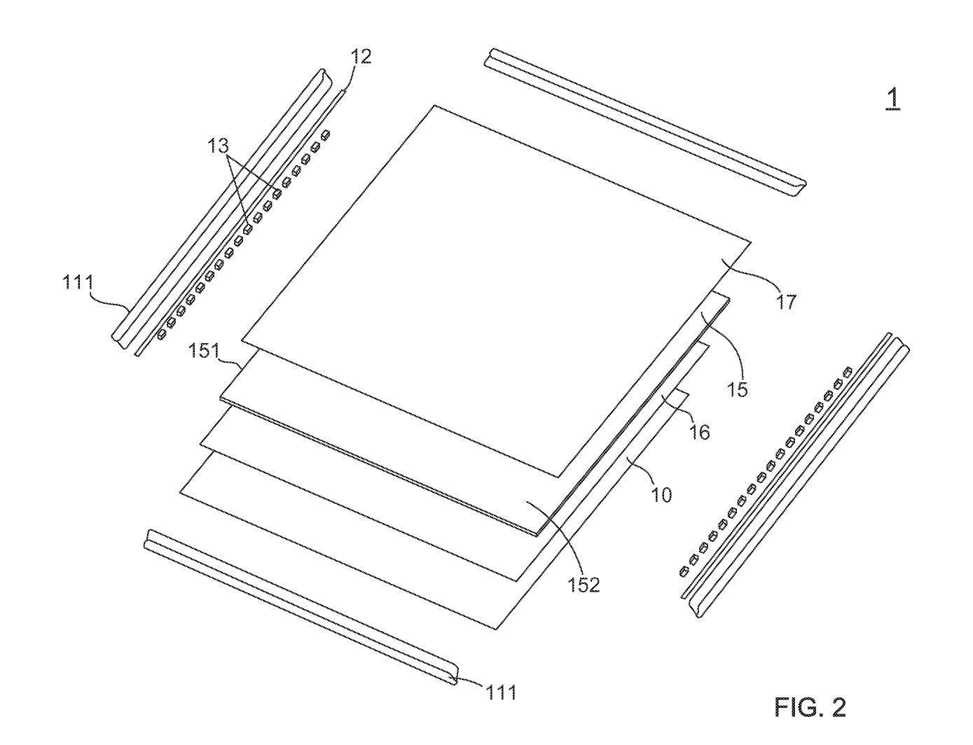

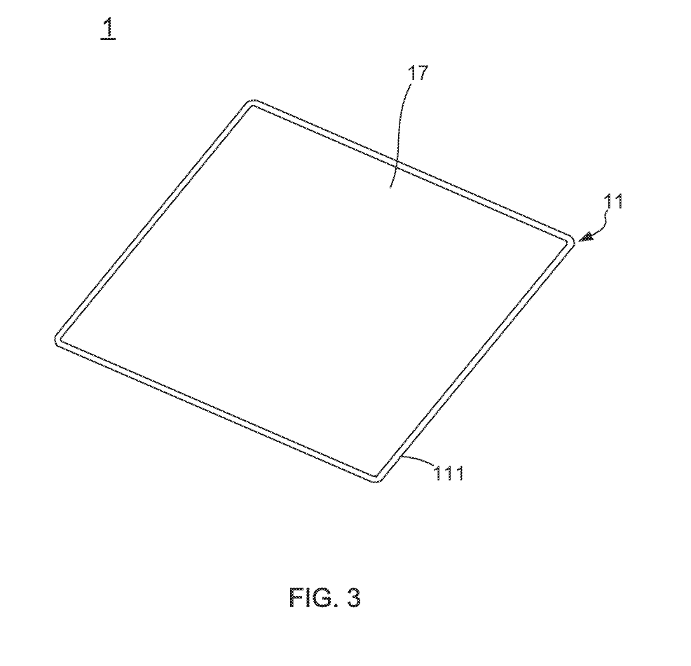

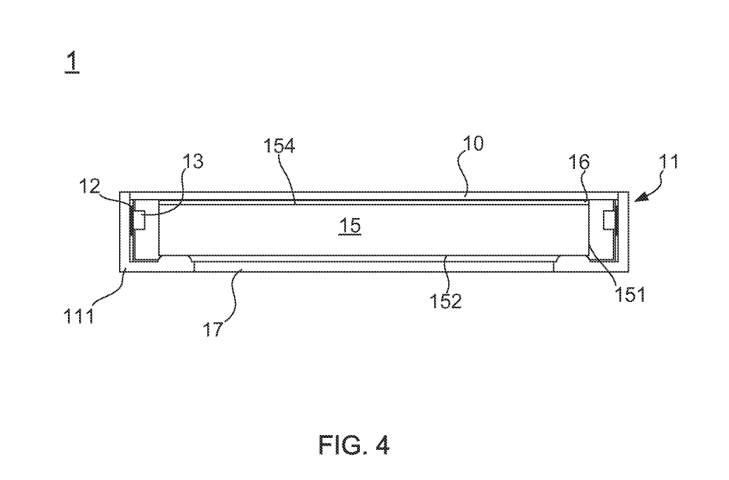

Please refer to FIG. 2, FIG. 3 and FIG. 4, there are shown an exploded view, a stereo view and a cross-sectional view of the LED panel lighting device according to the present invention. As shown in FIG. 2, FIG. 3 and FIG. 4, the LED panel lighting device 1 of the present invention consists of: a back framework 10, an assembled housing 11, two circuit layers 12, a plurality of LED chips 13, a light guide plate 15, a bottom reflective member 16, and an optical diffusion member 17.

The assembled housing 11 is consisted of a plurality of housing edges 111, and combined with the back framework 10 by way of enclosing the back framework 10. In some exemplary embodiments, the housing edges 111 can be a sheet-metal type housing edge or an extrusion-metal type housing edge. The two circuit layers 12 are respectively disposed in the two housing edges 111 of the assembled housing 11 by a thermal conductive and electric insulating member, and the LED chips 13 are disposed on the circuit layers 12. The light guide plate 15 is disposed in the assembled housing 11 and on the back framework 10. As shown in FIGs., the light guide plate 15 has two light receiving surfaces 151 and a light emitting surface 152, wherein the light receiving surfaces 151 is used for receiving the light emitted from the LED chips 13, and then the light emitting surface 152 would further provide a light source. In addition, the bottom reflective member 16 is disposed on the bottom surface of the light guide plate 15, and the optical diffusion member 17 is disposed on the light emitting surface 152 of the light guide plate 15, used for homogenizing the light source. Moreover, In the present invention, two reflective layers are formed on the inner surface of the housing edges 111 by way of spraying coating, and opposite to the LED chips 13.

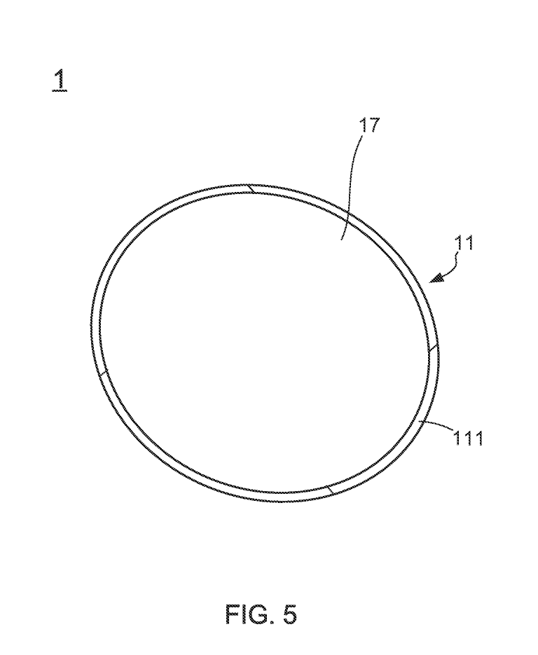

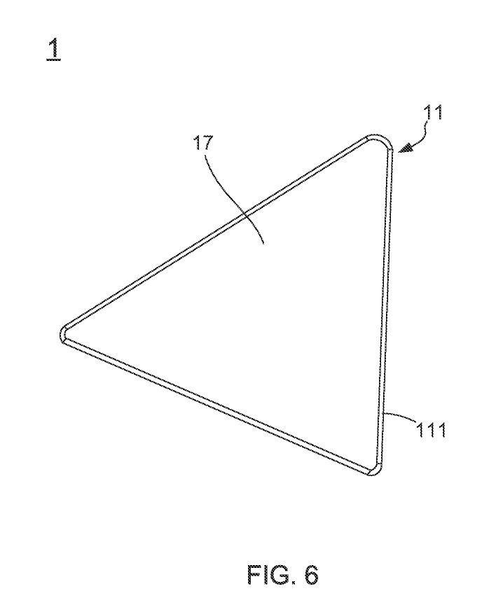

Continuously referring to FIG. 5 and FIG. 6, there are shown a second stereo view and a third stereo view of the LED panel lighting device, respectively. As shown in FIG. 5 and FIG. 6, the appearance of the LED panel lighting device 1 is limited by the number of the housing edges 111. For example, if the assembled housing 11 of the LED panel lighting device 1 is consisted of 3 housing edges 111, the appearance of the LED panel lighting device 1 is triangular shape; and similarly, f the assembled housing 11 of the LED panel lighting device 1 is consisted of 4 housing edges 111, the appearance of the LED panel lighting device 1 is square shape. Of course, depending on different number of the housing edges 111, the appearance of the LED panel lighting device 1 can also be circular shape, pentagonal shape and hexagonal shape.

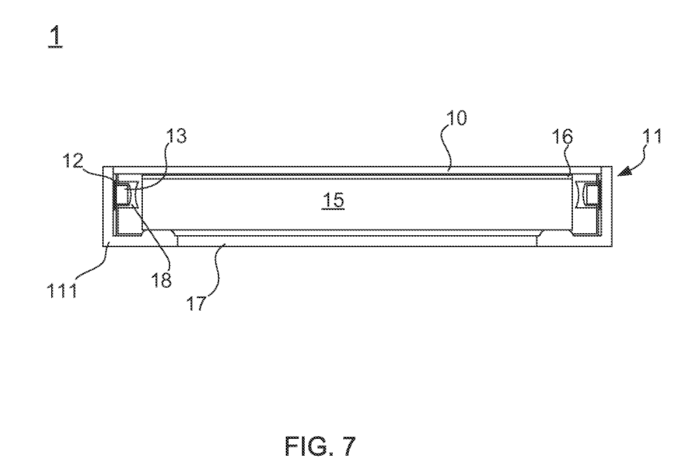

Please refer to FIG. 7, which illustrates a second cross-sectional view of the LED panel lighting device. For reducing the total amount of the LED chips 13, a plurality of lens 18 are disposed on the circuit layers 12 opposite to the LED chips 13 as shown in FIG. 7, and the lens 18 are used for covering the LED chips 13, so as to refract and scatter the light emitted by the LED chips 13. Therefore, entire brightness of the LED panel lighting device 1 even if the number of the LED chips 13 have been reduced.

Thus, through the descriptions, the LED panel lighting device of the present invention has been completely introduced and disclosed. In summary, the present invention has the following advantages:

1. Comparing to the conventional LED panel lighting device, the present invention attaches the circuit layers 12 in the housing edges 111 by a thermal conductive and electric insulating layer; so that, this LED panel lighting device 1 would not produce any heat accumulation issue because of without any MCPCB. Therefore, when the LED chips emit light, the heat produced by the LED chips would be rapidly conducted to the housing edges 111, so as to be dissipated.
2. Moreover, because without the MCPCB, the housing edges 111 can be made to be thinner.

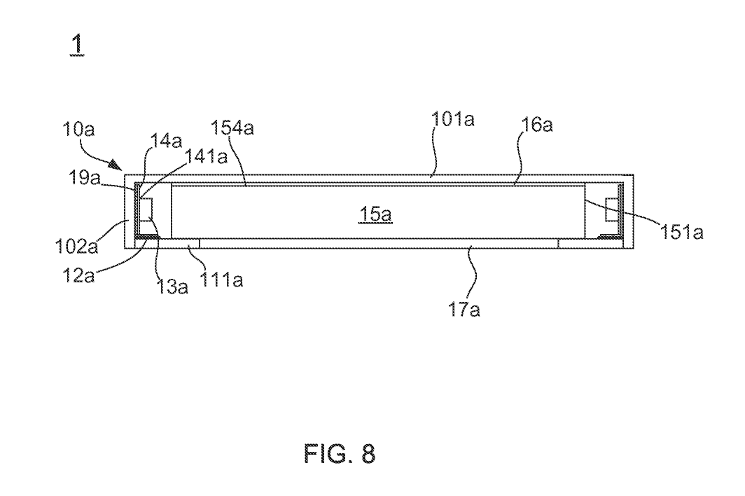

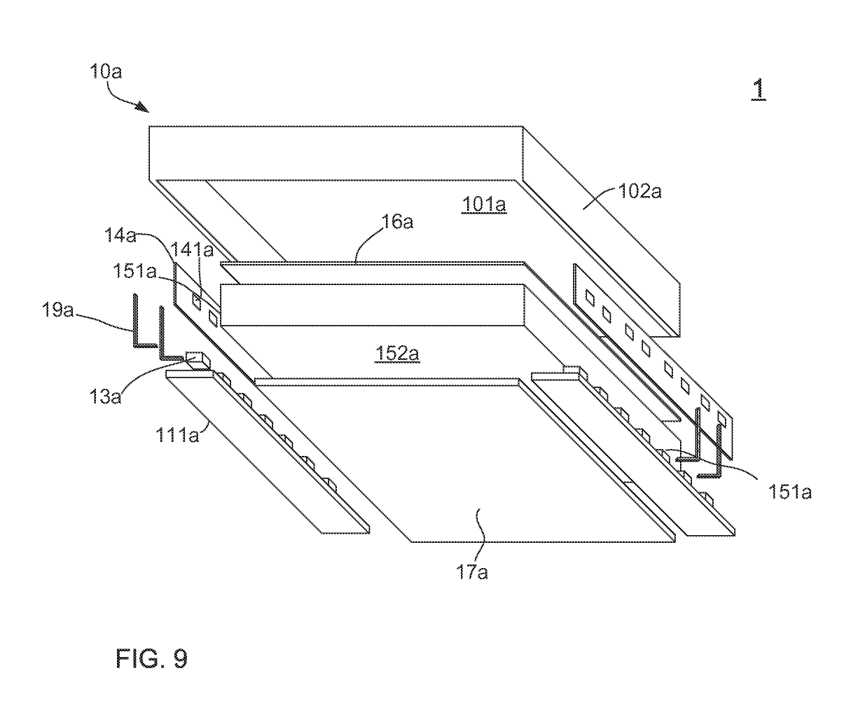

The LED panel lighting device of the present invention further includes a second embodiment. Please refer to FIG. 8 and FIG. 9, there are shown a cross-sectional view and a stereo view of the second embodiment of the LED panel lighting device. As shown in FIG. 8 and FIG. 9, the second embodiment of the LED panel lighting device 1 consists of: a geometric-shaped back framework 10a, two circuit carrying bodies 111a, two circuit layers 12a, a plurality of soldering metal sheets 19a, a plurality of LED chips 13a, a light guide plate 15a, a bottom reflective member 16a, and an optical diffusion member 17a, wherein the geometric-shaped back framework 10a is consisted of a bottom plate 101a and a plurality of edges 102a, and the two circuit carrying bodies 111a are disposed in the geometric-shaped back framework 10a and closely adjoining the edges 102a. In addition, the two circuit layers 12a are disposed on the circuit carrying bodies 111a by a thermal conductive and electric insulating member.

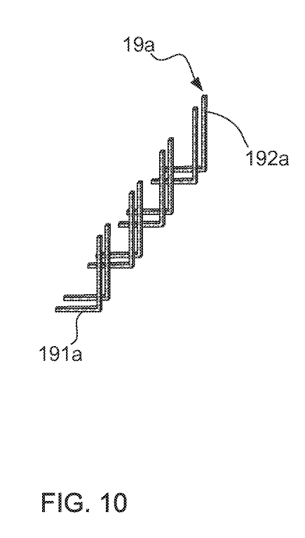

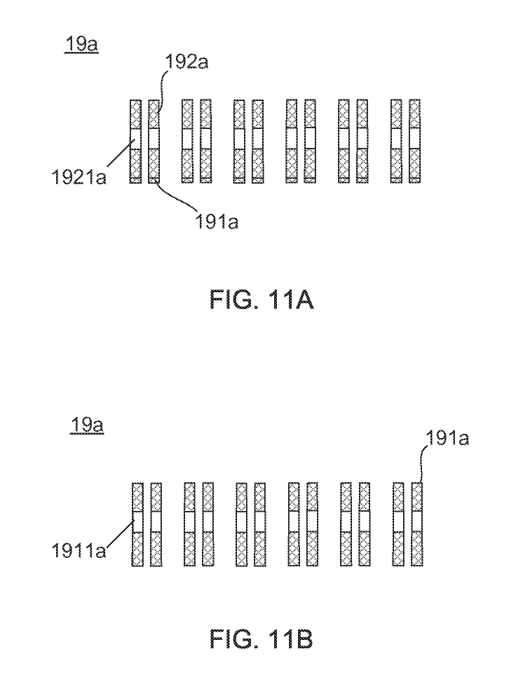

Continuously referring to FIG. 8 and FIG. 9, and please simultaneously refer to FIG. 10, FIG. 11A, and FIG. 11B, there are shown a stereo view, a front view and a bottom view of the soldering metal sheets. As shown in FIG. 10, in the second embodiment of the LED panel lighting device 1, each of the soldering metal sheets 19a have a first soldering portion 191a and a second soldering portion 192a, and the first soldering portion 191a is provided with an insulating layer with a first opening 1911a on the inner and outer surfaces thereof. Moreover, as shown in FIG. 11B, the first opening 1911a is used for being welded with a plurality of welding pads of the circuit layers 12a. Furthermore, as shown in FIG. 11B, the second soldering portion 192a is also provided with an insulating layer with a second opening 1921a on the inner and outer surfaces, and the second opening 1921a is used for being welded with the plurality of welding pads of the circuit layers 12a.

Inheriting to above descriptions, the LED chips 13a are welded on the second soldering portions 192a via the second openings 1921a, and electrically connected to the circuit layers via the soldering metal sheets 19a. Besides, an includes angle is provide between the first soldering portion 191a and the second soldering portion 192a, used for adjusting the light emitting position of the LED chips 13a, so as to facilitate the light guide plate receive the light efficiently.

The light guide plate 15a is disposed in the geometric-shaped back framework 10a and located on the bottom plate 101a. The light guide plate 15a has two light receiving surfaces 151a and a light emitting surface 152a, wherein the light receiving surfaces 151a is used for receiving the light emitted from the LED chips 13a, and then the light emitting surface 152a would further provide a light source. In addition, the bottom reflective member 16a is disposed on the bottom surface of the light guide plate 15a, and the optical diffusion member 17a is disposed on the light emitting surface 152a of the light guide plate 15a, used for homogenizing the light source.

Moreover, in the second embodiment of the LED panel lighting device 1 of the present invention, two reflective members 14a are disposed at the front of the soldering metal sheets 19a, and located between the soldering metal sheets 19a and the LED chips 13a. Each of the reflective members 14a have a plurality of through hole 141a, used for exposing the LED chips 13a out. Besides, what does the same to the above-mentioned embodiment is that, in the second embodiment of the LED panel lighting device 1, the appearance of the second embodiment of the LED panel lighting device 1 can be fabricated to be circular shape, triangular shape, square shape, pentagonal shape, or hexagonal shape depending on the appearance of the geometric-shaped back framework 10a.

Thus, through the descriptions, the second embodiment of the LED panel lighting device of the present invention has been completely introduced and disclosed. In summary, the present invention has the following advantages:

1. Comparing to the conventional LED panel lighting device, the present invention attaches the circuit layers 12a in the circuit carrying bodies 111a by a thermal conductive and electric insulating layer; so that, this LED panel lighting device 1 would not produce any heat accumulation issue because of without any MCPCB. Therefore, when the LED chips emit light, the heat produced by the LED chips would be rapidly conducted to the circuit carrying bodies 111a, so as to be dissipated.
2. Moreover, because without the MCPCB, the second embodiment of the LED panel lighting device s can be made to be thinner.

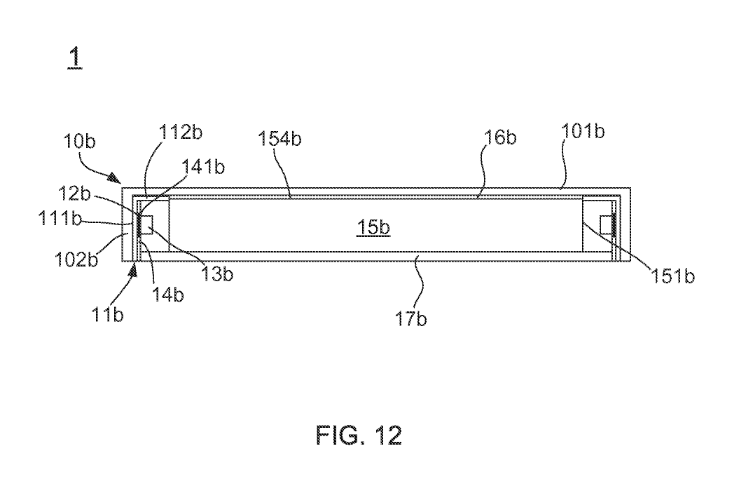

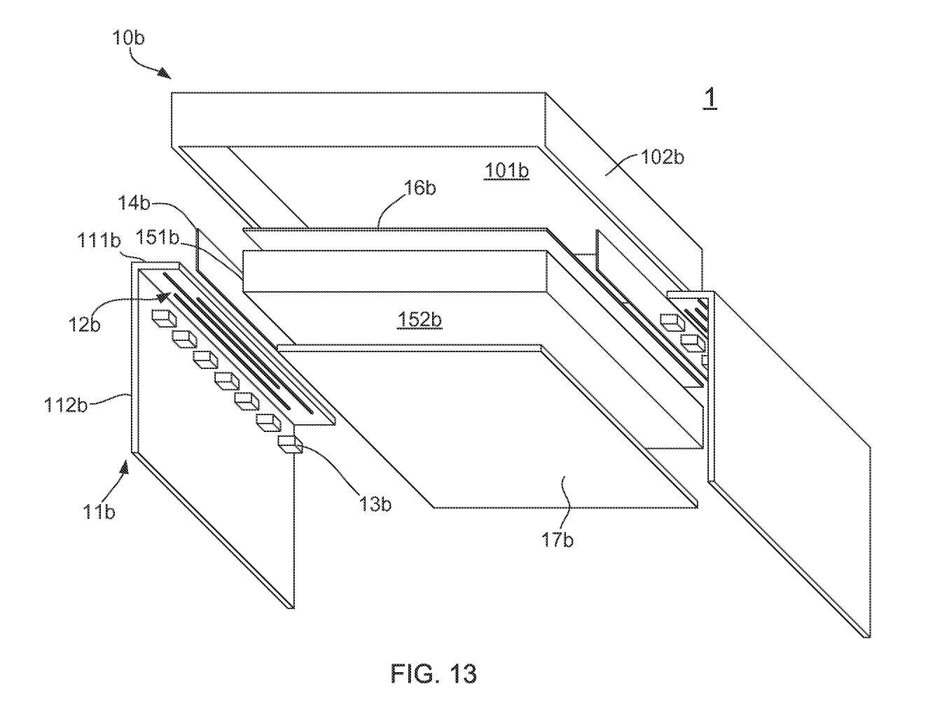

The LED panel lighting device of the present invention further includes a third embodiment. Please refer to FIG. 12 and FIG. 13, there are shown a cross-sectional view and a stereo view of the third embodiment of the LED panel lighting device. As shown in FIG. 12 and FIG. 13, the third embodiment of the LED panel lighting device 1 consists of: a geometric-shaped back framework 10b, two housing 11b, two circuit layers 12b, a plurality of LED chips 13b, a light guide plate 15b, a bottom reflective member 16b, and an optical diffusion member 17b, wherein the geometric-shaped back framework 10b is consisted of a bottom plate 101b and a plurality of edges 102b. What does the same to above-mentioned second embodiment is that, the appearance of the third embodiment of the LED panel lighting device 1 can be fabricated to be circular shape, triangular shape, square shape, pentagonal shape, or hexagonal shape depending on the appearance of the geometric-shaped back framework 10b.

The housing 11b are disposed in the geometric-shaped back framework 10b and closely adjoining the edges 102b, wherein each of the housing 11b have a first disposing portion 111b and a second disposing portion 121b. The two circuit layers 12b are disposed on the first disposing portions 111b by a thermal conductive and electric insulating member, and the LED chips 13b are disposed on the circuit layers 12b. As shown in FIGs., the first disposing portion 111b and the second disposing portion 121b are the bottom edge and the side edge of the housing 11b; however, that does not be used to limit the structure of the housing 11b. In some exemplary embodiment, the first disposing portion 111b and the second disposing portion 121b can also be the side edge and the bottom edge of the housing 11b.

In addition, the light guide plate 15b is disposed in the geometric-shaped back framework 10b and located on the bottom plate 101b. The light guide plate 15b has two light receiving surfaces 151b and a light emitting surface 152b, wherein the light receiving surfaces 151b is used for receiving the light emitted from the LED chips 13b, and then the light emitting surface 152b would further provide a light source. Moreover, the bottom reflective member 16b, being disposed on the bottom surface of the light guide plate 15b, and the optical diffusion member 17b, being disposed on the light emitting surface 152b of the light guide plate 15b, used for homogenizing the light source. As shown in FIG. 12, because the circuit layers 12b are attached to the side edges of the housings 11b, the LED chips 13a disposed on the first disposing portion 111b respectively pass through out of the through holes 141b of the reflective layers 14b.

Thus, through the descriptions, the third embodiment of the LED panel lighting device of the present invention has been completely introduced and disclosed. In summary, the present invention has the following advantages:

Comparing to the conventional LED panel lighting device, the present invention attaches the circuit layers 12b in the first disposing portions 111b of the housings 11b by a thermal conductive and electric insulating layer; so that, this LED panel lighting device 1 would not produce any heat accumulation issue because of without any MCPCB. Therefore, when the LED chips emit light, the heat produced by the LED chips would be rapidly conducted to the housing 11b, so as to be dissipated.

2. Moreover, because without the MCPCB, the third embodiment of the LED panel lighting device s can be made to be thinner.

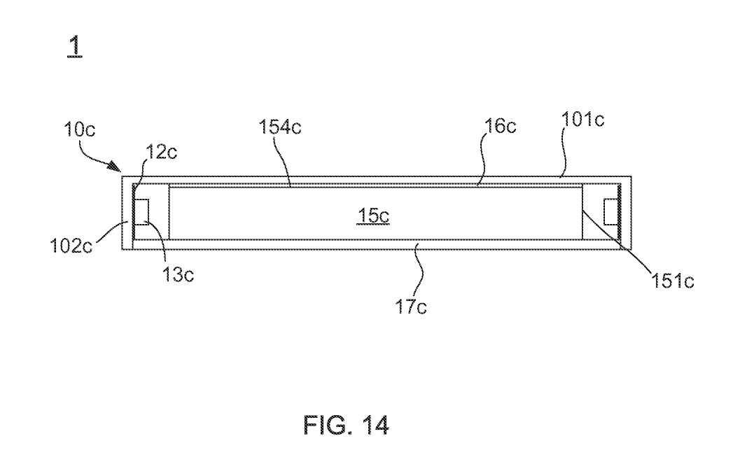

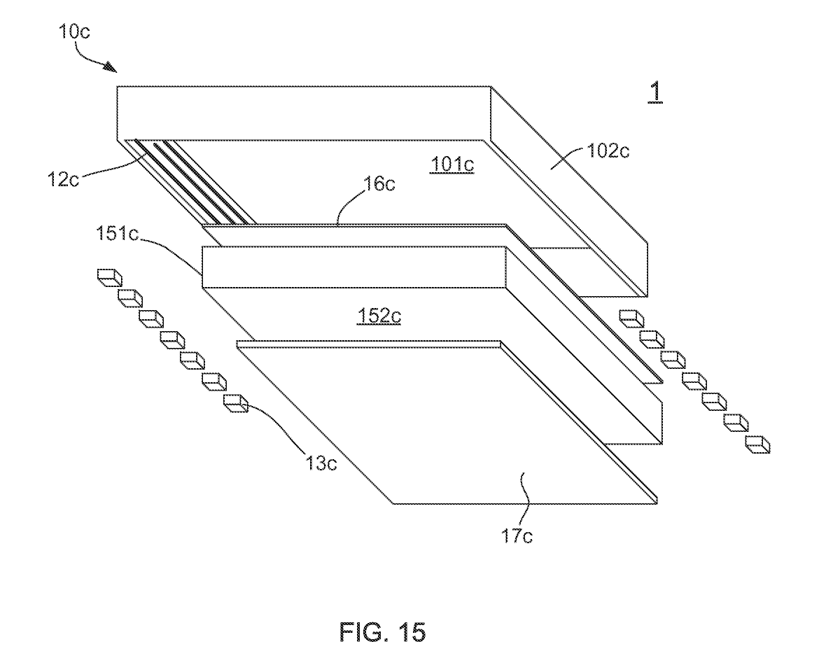

The LED panel lighting device of the present invention further includes a fourth embodiment. Please refer to FIG. 14 and FIG. 15, there are shown a cross-sectional view and a stereo view of the fourth embodiment of the LED panel lighting device. As shown in FIG. 14 and FIG. 15, the fourth embodiment of the LED panel lighting device 1 consists of: a geometric-shaped back framework 10c, two circuit layers 12c, a plurality of LED chips 13c, a light guide plate 15c, a bottom reflective member 16c, and an optical diffusion member 17c, wherein the two circuit layers 12c are disposed on the edges 102c by a thermal conductive and electric insulating member. What does the same to above-mentioned third embodiment is that, the appearance of the fourth embodiment of the LED panel lighting device 1 can be fabricated to be circular shape, triangular shape, square shape, pentagonal shape, or hexagonal shape depending on the appearance of the geometric-shaped back framework 10c.

Inheriting to above descriptions, the LED chips 13c is disposed on the circuit layers 12c, and the light guide plate 15c is disposed in the geometric-shaped back framework 10c and located on the bottom plate 101c. The light guide plate 15c has two light receiving surfaces 151c and a light emitting surface 152c, wherein the light receiving surfaces 151c is used for receiving the light emitted from the LED chips 13c, and then the light emitting surface 152c would further provide a light source. Moreover, the bottom reflective member 16c is disposed on the bottom surface of the light guide plate 15c, and the optical diffusion member 17c is disposed on the light emitting surface 152c of the light guide plate 15c, used for homogenizing the light source.

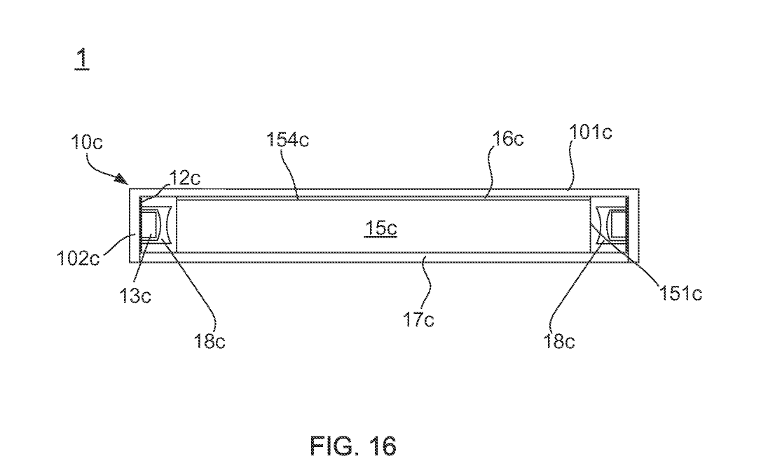

Please further refer to FIG. 16, which illustrates a second cross-sectional view of the fourth embodiment of the LED panel lighting device. For reducing the total amount of the LED chips 13c, a plurality of lens 18c are disposed on the circuit layers 12c opposite to the LED chips 13c as shown in FIG. 16, and the lens 18c are used for covering the LED chips 13c, so as to refract and scatter the light emitted by the LED chips 13c. Therefore, entire brightness of the LED panel lighting device 1 even if the number of the LED chips 13c have been reduced.

The above description is made on embodiments of the present invention. However, the embodiments are not intended to limit scope of the present invention, and all equivalent implementations or alterations within the spirit of the present invention still fall within the scope of the present invention.

What is claimed is:

1. An LED panel lighting device, comprising:
a back framework;
an assembled housing, being consisted of a plurality of housing edges, and combined with the back framework by way of enclosing the back framework;
at least two circuit layers, being disposed in two housing edges of the assembled housing by a thermal conductive and electric insulating member;
a plurality of LED chips, being disposed on the circuit layers;
a light guide plate, being disposed in the assembled housing and on the back framework, and having at least two light receiving surfaces and a light emitting surface, wherein the light receiving surfaces is used for receiving the light emitted from the LED chips, and then the light emitting surface would further provide a light source;
a bottom reflective member, being disposed on the bottom surface of the light guide plate; and
an optical diffusion member, being disposed on the light emitting surface of the light guide plate, used for homogenizing the light source.

2. The LED panel lighting device of claim 1, further comprising: at least two reflective layers, being formed on the circuit layers opposite to the LED chips.

3. The LED panel lighting device of claim 1, wherein the housing edge is selected from the group consisting of: sheet-metal type housing edge and extrusion-metal type housing edge.

4. The LED panel lighting device of claim 1, wherein the appearance of the housing edge is selected from the group consisting of: circular shape, triangular shape, square shape, pentagonal shape, and hexagonal shape.

5. The LED panel lighting device of claim 2, further comprising a plurality of lens, which are disposed on the circuit layers opposite to the LED chips, and used for covering the LED chips, so as to refract and scatter the light emitted by the LED chips.

6. An LED panel lighting device, comprising:
a geometric-shaped back framework, being consisted of a bottom plate and a plurality of edges;
at least two circuit carrying bodies, being disposed in the geometric-shaped back framework and closely adjoining the edges;
at least two circuit layers, being disposed on the circuit carrying bodies by a thermal conductive and electric insulating member;
a plurality of soldering metal sheets, wherein each of the soldering metal sheets have a first soldering portion and a second soldering portion, and the first soldering portion being provided having an insulating layer with a first opening on the inner and outer surfaces thereof, in which the first opening is used for being welded with a plurality of welding pads of the circuit layers; moreover, the second soldering portion being also provided having an insulating layer with a second opening on the inner and outer surfaces, and the second opening being used for being welded with the plurality of welding pads of the circuit layers;
a plurality of LED chips, being welded on the second soldering portions via the second openings, and electrically connected to the circuit layers via the soldering metal sheets;
a light guide plate, being disposed in the geometric-shaped back framework and located on the bottom plate, and having at least two light receiving surfaces and a light emitting surface, wherein the light receiving surfaces is used for receiving the light emitted from the LED chips, and then the light emitting surface would further provide a light source;
a bottom reflective member, being disposed on the bottom surface of the light guide plate; and
an optical diffusion member, being disposed on the light emitting surface of the light guide plate, used for homogenizing the light source.

7. The LED panel lighting device of claim 6, further comprising: at least two reflective members, being disposed at the front of the soldering metal sheets, and located between the soldering metal sheets and the LED chips.

8. The LED panel lighting device of claim 6, wherein the appearance of the geometric-shaped back framework is selected from the group consisting of: circular shape, triangular shape, square shape, pentagonal shape, and hexagonal shape.

9. The LED panel lighting device of claim 7, wherein the reflective member comprises a plurality of through holes, used for exposing the LED chips out.

10. The LED panel lighting device of claim 6, wherein an included angle is provided between the first soldering portion and the second soldering portion of the soldering metal sheet.

11. An LED panel lighting device, comprising:
a geometric-shaped back framework, being consisted of a bottom plate and a plurality of edges;
at least two housing, being disposed in the geometric-shaped back framework and closely adjoining the edges, wherein each of the housing have a first disposing portion and a second disposing portion;
at least two circuit layers, being disposed on the first disposing portions by a thermal conductive and electric insulating member;
a plurality of LED chips, being disposed on the circuit layers;
a light guide plate, being disposed in the geometric-shaped back framework and located on the bottom plate, and having at least two light receiving surfaces and a light emitting surface, wherein the light receiving surfaces is used for receiving the light emitted from the LED chips, and then the light emitting surface would further provide a light source;
a bottom reflective member, being disposed on the bottom surface of the light guide plate; and
an optical diffusion member, being disposed on the light emitting surface of the light guide plate, used for homogenizing the light source.

12. The LED panel lighting device of claim 11, further comprising: at least two reflective members, being disposed on the second disposing portions.

13. The LED panel lighting device of claim 11, wherein the appearance of the geometric-shaped back framework is selected from the group consisting of: circular shape, triangular shape, square shape, pentagonal shape, and hexagonal shape.

14. The LED panel lighting device of claim 12, wherein the housing is selected from the group consisting of: sheet-metal type housing and extrusion-metal type housing.

15. The LED panel lighting device of claim 14, wherein the reflective member comprises a plurality of through holes, used for exposing the LED chips out.

16. An LED panel lighting device, comprising:
a geometric-shaped back framework, being consisted of a bottom plate and a plurality of edges;
at least two circuit layers, being disposed on the edges by a thermal conductive and electric insulating member;
a plurality of LED chips, being disposed on the circuit layers;
a light guide plate, being disposed in the geometric-shaped back framework and located on the bottom plate, and having at least two light receiving surfaces and a light emitting surface, wherein the light receiving surfaces is used for receiving the light emitted from the LED chips, and then the light emitting surface would further provide a light source;
a bottom reflective member, being disposed on the bottom surface of the light guide plate; and
an optical diffusion member, being disposed on the light emitting surface of the light guide plate, used for homogenizing the light source.

17. The LED panel lighting device of claim 16, further comprising: at least two reflective members, being disposed on the circuit layers.

18. The LED panel lighting device of claim 16, wherein the appearance of the geometric-shaped back framework is selected from the group consisting of: circular shape, triangular shape, square shape, pentagonal shape, and hexagonal shape.

19. The LED panel lighting device of claim 16, further comprises a plurality of lens 18, which are disposed on the circuit layers opposite to the LED chips, and used for covering the LED chips, so as to refract and scatter the light emitted by the LED chips.
